(19) United States
(12) Patent Application Publication
(10) Pub. No.: US 2007/0285550 A1
(43) Pub. Date: Dec. 13, 2007

(54) Method and apparatus for taking images using mobile communication terminal with plurality of camera lenses

(75) Inventor: Jae-Gon Son, Daegu Metropolitan City (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/642,841

(22) Filed: Dec. 21, 2006

(30) Foreign Application Priority Data
Jun. 13, 2006 (KR) 2006-52951

(51) Int. Cl. H04N 5/225; G02B 13/16

(52) U.S. Cl. 348/335

(57) ABSTRACT

Provided are a method and apparatus for taking images using a mobile communication terminal with a plurality of camera lenses, that can visually emphasize the shape of an object by photographing a specific object and its surrounding background using a zoom lens and a wide-angle lens, respectively, and combining the photographed images. The method includes setting the mobile communication terminal to an image-taking mode, entering into an image-combining mode, operating the plurality of camera lenses, setting an object, taking images using the plurality of camera lenses, and combining together the images obtained using the plurality of lenses. The method and apparatus enables visual emphasis of a specific object in an entire image by photographing the specific object with a zoom lens and a background containing the object with a wide-angle lens, and then combining the photographed images so as to display the specific object at a higher magnification ratio than that of the background.

### CROSS-REFERENCE TO RELATED REFERENCE

This application claims the benefit under 35 U.S.C. §119(a) of a Korean Patent Application filed in the Korean Intellectual Property Office on Jun. 13, 2006 and assigned Serial No. 2006-52951, the entire disclosure of which is hereby incorporated by reference.

### BACKGROUND OF THE INVENTION

1. Field of the Invention

The present invention relates to a method and apparatus for taking images using a mobile communication terminal with a plurality of camera lenses. More particularly, the present invention relates to a method and apparatus for taking images using a mobile communication terminal with a zoom lens and a wide-angle lens and combining the photographed images.

2. Description of the Related Art

In general, a user of a mobile communication terminal with a single camera lens takes a photograph of a specific object simultaneously with background objects.

However, because a single camera lens only allows photographs of a specific object and its surrounding background to be taken at the same magnification ratio, the object may not be visually emphasized. Due to a lack of visual emphasis, for example, it may be difficult to identify a specific person in a picture of a group of people.

When taking a photograph using a conventional mobile communication terminal equipped with two camera lenses (“dual lens”), a first camera lens focuses on a specific object and a second camera lens for wide-angle imaging takes a photograph of a background area not covered by the first camera lens. The conventional mobile communication terminal with a dual lens enhances panoramic features but still cannot visually emphasize an object, as with the above-mentioned mobile communication terminal with a single camera lens.

### SUMMARY OF THE INVENTION

Accordingly, certain exemplary embodiment of the present invention is to address at least the above-mentioned problems and/or disadvantages. An object of exemplary embodiments of the present invention is to provide a method and apparatus for taking images using a mobile communication terminal, which can visually emphasize the shape of an object by photographing a specific object and its surrounding background using a zoom lens and a wide-angle lens, respectively, and combining the photographed images.

Another object of the exemplary embodiments of the present invention is to provide a method and apparatus for taking images using a mobile communication terminal with a plurality of camera lenses, which allow visual emphasis on a specific object by inserting the specific object into a background image.

In order to achieve the above objects, according to an exemplary embodiment of the present invention, a method for taking images using a mobile communication terminal with a plurality of camera lenses is provided. The method includes entering into an image-combining mode, operating the plurality of camera lenses, setting an object, taking images using the plurality of camera lenses, and combining together the images obtained using the plurality of lenses.

In an exemplary implementation, in the step of setting an object, a reference position for photography may be established.

In an exemplary implementation, the plurality of camera lenses includes at least one zoom lens and at least one wide-angle lens.

The zoom lens may photograph the object and the wide-angle lens may photograph a background containing the object. The photographing operations using the zoom lens and the wide-angle lens are performed substantially simultaneously.

In the combining together of the images obtained using the plurality of lenses, an image obtained using the zoom lens is combined with an image obtained using the wide-angle lens. That is, an object image obtained using the zoom lens is combined with an image obtained using the wide-angle lens, excluding an area corresponding to the object image.

In an exemplary implementation, a method for excluding an area corresponding to an object image obtained using the zoom lens from an image obtained using the wide-angle lens includes setting a common reference point for photography to the specific object when images are taken using the zoom lens and the, wide-angle lens, determining image areas to be photographed with the zoom lens and wide-angle lens using the position measuring system of the mobile communication terminal, and excluding the image area obtained with the zoom lens from the image area obtained with the wide-angle lens using the position measuring system.

The reference position for photography may be established by using the position measuring system of the mobile communication terminal.

The position measuring system of the mobile communication terminal includes at least one of a local area communication system, an ultrasonic position measuring system, and a global positioning system (GPS). In accordance with another exemplary embodiment of the present invention, an apparatus for taking images using a mobile communication terminal with a plurality of camera lenses is provided. The apparatus includes an image-taking mode setter for setting an image-taking mode in which an object is photographed, a photographing unit having the plurality of camera lenses including at least one zoom lens and at least one wide-angle lens, an object setter for setting an object for the plurality of camera lenses, and an image combiner for combining together images obtained using the plurality of lenses.

In an exemplary implementation, the image combiner combines images obtained using the zoom lens and the wide-angle lens.

In an exemplary implementation, the apparatus further includes a reference position setter for setting a reference position for photography for the plurality of camera lenses.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of the present invention will be more apparent from the following detailed description in conjunction with the accompanying drawings, in which:

FIG. 1 is a schematic block diagram illustrating a configuration of an apparatus for taking images using a mobile communication terminal with a plurality of camera lenses according to an exemplary embodiment of the present invention; and

FIG. 2 is a flowchart illustrating a method for taking images using a mobile communication terminal with a plurality of camera lenses according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of the present invention are described in detail with reference to the accompanying drawings. Constructions or processes known in the art may be not described to avoid obscuring the invention in unnecessary detail. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

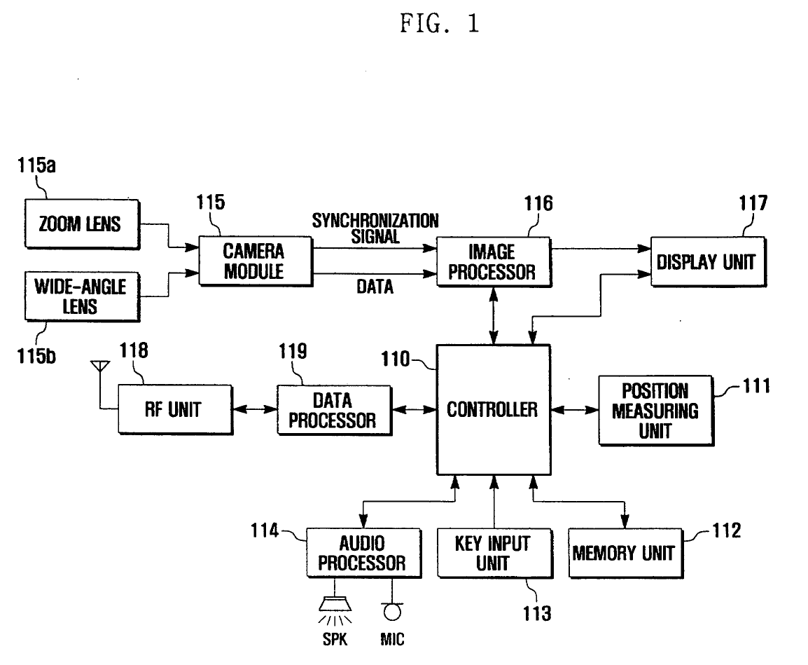

FIG. 1 is a schematic block diagram illustrating a configuration of an apparatus for taking images using; a mobile communication terminal with a plurality of camera lenses according to an exemplary embodiment of the present invention.

The mobile communication terminal used in an exemplary embodiment of the present embodiment has a camera function and a mobile communication function. Referring to FIG. 1, the apparatus includes a mobile communication terminal controller (hereinafter “controller”) 110, memory unit 112, key input unit 113, audio processor 114, camera module 115, image processor 116, display unit 117, radio frequency (RF) unit 118, and data processor 119.

The RF unit 118 performs wireless communications of the mobile communication terminal. The RF unit 118 includes an RF transmitter that up-converts the frequency of a signal being transmitted and amplifies the signal and an RF receiver that low-noise amplifies a signal being received and down-converts its frequency.

The data processor 119 encodes and modulates the signal being transmitted and demodulates and decodes the signal being received. That is, the data processor 119 includes a modulator/demodulator (modem) and a coder/decoder (codec). The codec includes a data codec for processing incoming data such as packet data and an audio codec for processing audio signals such as voice.

The memory unit 112 stores data information and temporarily stores data generated during the operation of the mobile communication terminal. The audio processor 114 reproduces a received audio signal output from the audio codec of the data processor 119 or outputs an audio signal generated through a microphone MIC to the audio codec of the data processor 119 or transmission.

The camera module 115 includes a plurality of camera lenses that collect rays of light from an object for photographing the object, a camera sensor that converts the photographed optical signal into an electrical signal, and a signal processor that converts an analog image signal output from the camera sensor to digital data. The camera sensor may be a charge coupled device (CCD) sensor. The signal processor may be a digital signal processor (DSP).

The camera sensor and the signal processor may be integrated into a single unit or may be two separate devices.

The plurality of camera lenses includes at least one zoom lens 115a for taking a photograph of the object and at least one wide-angle lens 115b for taking a photograph of a background containing the object.

The photographing operations using the zoom lens 115a and the wide-angle lens 115b are performed simultaneously.

The controller 110 performs the overall control operation of the mobile communication terminal. The controller 110 may also include the data processor 119. According to an exemplary embodiment of the present invention, the controller 110 is connected to the memory unit 112, the audio processor 114, the image processor 116, the display unit 117, and the data processor 119 to control the operations of exchanging, processing data and placing a call.

The controller 110 uses an image signal from the image processor 116 to combine the photographed object image and background image and controls the display unit 117 to display the object image at a higher magnification ratio than the background image, resulting in a visual emphasis on the object image. In an exemplary implementation, the controller 110 combines an object image obtained using the zoom lens 115a with a background image obtained using the wide-angle lens 115b.

More specifically, the controller 110 combines an object image obtained using the zoom lens 115a with a background image obtained using the wide-angle lens 115b, excluding an area corresponding to the object image.

A method for excluding an area corresponding to the object image obtained with the zoom lens 115a from the background image obtained with the wide-angle lens 115b includes setting a common reference point for photography to the specific object when images are taken using the zoom lens 115a and the wide-angle lens 115b, defining image areas to be photographed with the zoom lens 115a and wide-angle lens 115b using a position measuring system in a position measuring unit 111 of the mobile communication terminal, and excluding the image area obtained with the zoom lens 115a from the image area obtained with the wide-angle lens 115b using the position measuring system.

In this case, the position measuring system of the mobile communication terminal may include at least one of a local area communication system, an ultrasonic position measuring system, and a global positioning system (GPS).

When the local area communication system is used, a relative position and distance between the mobile communication terminal having a local area communication function and the specific object having a local area communication function are determined by exchanging data therebetween, and the specific object and the background are photographed using the zoom lens 115a and the wide-angle lens 115b, respectively.

When the ultrasonic position measuring system is used, ultrasonic waves are radiated from the mobile communication terminal to the specific object to measure the distance between the mobile communication terminal and the specific object, and the specific object and the background are photographed using the zoom lens 115a and the wide-angle lens 115b, respectively.

When the GPS is used, a current position of the mobile communication terminal is set, and the specific object, which is located within a predetermined range in radius from the current position, and the background outside the range are photographed with the zoom lens 115a and the wide-angle lens 115b, respectively.

The reference point for photography may also be set using at least one of the above-mentioned three position measuring systems.

The image processor 116 generates screen data for displaying an image signal received from the camera module 115. The image processor 116 also processes the image signal received from the camera module 115 in frame units and outputs image data to match the display characteristics and size of the display unit 117. The image processor 116 also includes an image codec to compress the image data to be displayed on the display unit 117 using a predetermined compression technique and to decompress the compressed image data into original image data. The image codec may be a Joint Pictures Experts Group (JPEG) codec, Moving Pictures Experts Group (MPEG) codec, or Wavelet codec. It is assumed herein that the image processor 116 has an On Screen Display (OSD) function and is controlled by the controller 110 to output OSD data according to the size of the screen.

The display unit 117 displays an image signal output from the image processor 116 and data output from the controller 110 on a screen. The display unit 117 may include a liquid crystal display (LCD) or organic light-emitting diode (OLED) panel. The panel preferably has a touch-screen function.

The key input unit 113 includes keys for inputting phone numbers containing numeric and character information and function keys for setting various functions. The key input unit 113 may also be equipped with shortcut keys corresponding to these keys, such as sharp sign ‘#’ and asterisk ‘*’.

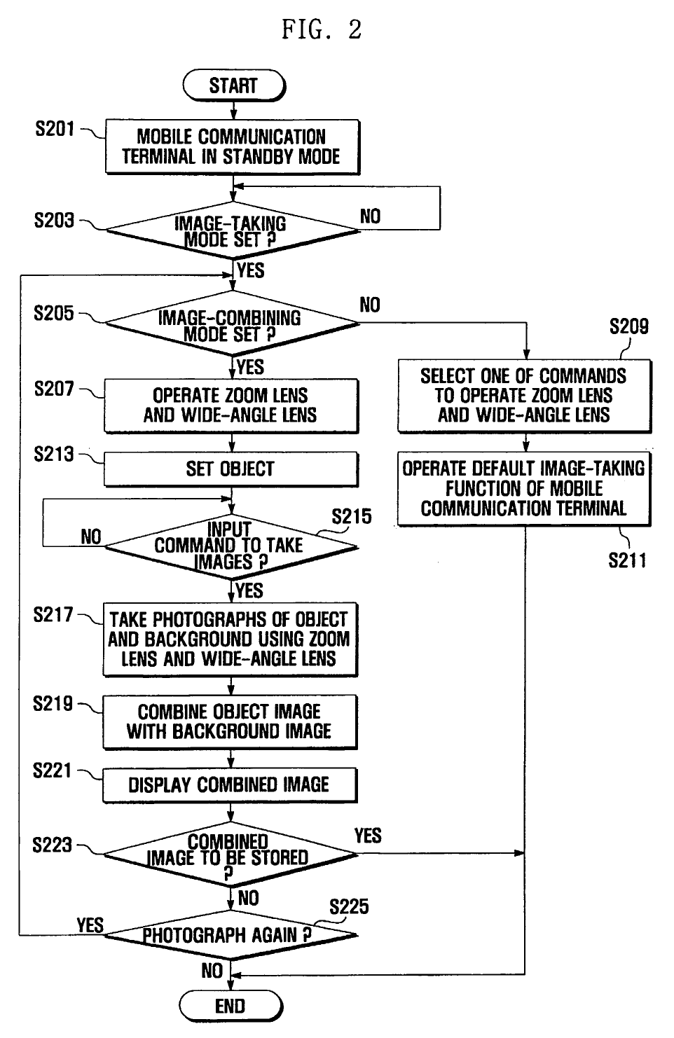

FIG. 2 is a flowchart illustrating a method for taking images using a mobile communication terminal with a plurality of camera lenses according to an exemplary embodiment of the present invention. The method is described in detail with reference to FIGS. 1 and 2.

The mobile communication terminal is in a standby mode at step S201. The controller 110 determines whether the mobile communication terminal has been set to an image-taking mode at step S203. A user of the mobile communication terminal can select an image-taking mode using touch screen, keypad input, or the like.

After entering into the image-taking mode, an enquiry is displayed on the display unit 117 asking the user whether to enter into an image-combining mode at step S205.

The user of the mobile communication terminal selects whether to enter into an image-combining mode using a keypad or touch screen input.

If a command not to select the image-combining mode is input, a message is displayed on the display unit 117 asking the user to select the zoom lens 115a or the wide-angle lens 115b at step S209.

When either of the zoom lens 115a or the wide-angle lens 115b is selected, the selected lens operates. A default image-taking function of the mobile communication terminal operates to take a photograph of a specific object without combining images at step S211.

If a command to select the image-combining mode is input in step S205, the zoom lens 115a and the wide-angle lens 115b operate substantially simultaneously at step S207. The specific object is set at step S213.

In an exemplary implementation, the object is set together with a reference position for photography.

The reference position for photography is set to replace a specific object area photographed with the wide-angle lens 115b with the specific object photographed with the zoom lens 115a when images are taken using the zoom lens 115a and the wide-angle lens 115b.

The reference position for photography is set using a position measuring system installed within the position measuring unit 111 of the mobile communication terminal. The position measuring system of the mobile communication terminal may include at least one of a local area communication system, an ultrasonic position measuring system, and a global positioning system (GPS).

The reference position for photography may also be set by using at least one of the above-mentioned three position measuring systems.

Next, the controller 110 determines whether a command to take images is input at step S215. If the command is input, photographing operations using the zoom lens 115a and the wide-angle lens 115b are performed simultaneously at step S217.

The zoom lens 115a is used to focus on and photograph the specific object and the wide-angle lens 115b is used to photograph a background area containing the object over a wide range.

An object image obtained with the zoom lens 115a is combined with a background image containing the object image obtained with the wide-angle lens 115b at step S219.

That is, a specific object image obtained using the zoom lens 115a is combined with a background image obtained using the wide-angle lens 115b, excluding an image area corresponding to the object image.

A method for excluding an image area corresponding to the object image obtained with the zoom lens 115a from the image obtained with the wide-angle lens 115b includes setting a common reference point for photography to the specific object when images are taken using the zoom lens 115a and the wide-angle lens 115b, defining image areas to be photographed with the zoom lens 115a and wide-angle lens 115b using a position measuring system in the mobile communication terminal, and excluding the image area obtained with the zoom lens 115a from the image area obtained with the wide-angle lens 115b using the position measuring system.

More specifically, an area containing the specific object, for example, circular or rectangular area, is set as an area A to be photographed with the zoom lens 115a and a surrounding background area containing the area A is set as an area B to be photographed with the wide-angle lens 115b. Thereafter, if a command to take images is input by the user of the mobile communication terminal, the controller 110 combines the images together, taken by the zoom lens 115a and the wide-angle lens 115b, by removing an image signal corresponding to a specific area, for example, corresponding to the area A, within the area B and replacing it with an image signal corresponding to the area A photographed with the zoom lens 115a.

An image obtained by combining the object image with the background image in step S219 is displayed on the display unit 117 or on a predetermined display device at step S221.

According to an exemplary embodiment of the present invention, because a specific object image, such as person or object, can be magnified compared with a background image, the specific object may be visually emphasized.

The controller 110 determines whether the user wants to store the combined image at step S223. The user inputs a command to store the combined image through a touch screen or keypads.

An enquiry is displayed on the display unit 117 asking whether to photograph again at step S225. If a command to photograph again is input, the process returns to step S205.

As described above, certain exemplary embodiments of the present invention enable visual emphasis of a specific object in an entire image by photographing the specific object with a zoom lens and a background containing the object with a wide-angle lens, and then combining the photographed images so as to display the specific object at a higher magnification ratio than that of the background.

While the present invention has been particularly shown and described with reference to exemplary embodiments thereof, it will be understood by those of ordinary skill in the art that various changes, modifications, substitutions and additions in form and details may be made without departing from the spirit and scope of the present invention as defined by the following claims and their equivalents.

What is claimed is:

1. A method for taking images using a mobile communication terminal with a plurality of camera lenses, comprising:
setting an object for the plurality of camera lenses;
taking images using the plurality of camera lenses; and
combining together the images obtained using the plurality of camera lenses.

2. The method of claim 1, wherein the setting of an object comprises setting a reference position for photography.

3. The method of claim 1, wherein the plurality of camera lenses comprises at least one zoom lens and at least one wide-angle lens.

4. The method of claim 3, wherein the zoom lens photographs the object and the wide-angle lens photographs a background containing the object.

5. The method of claim 4, wherein the taking of images comprises respective photographing operations using the zoom lens and the wide-angle lens that are performed substantially simultaneously.

6. The method of claim 2, wherein the setting of a reference position for photography uses a position measuring system of the mobile communication terminal.

7. The method of claim 1, wherein in the combining together of the images obtained using the plurality of lenses, an image obtained using a zoom lens is combined with an image obtained using a wide-angle lens, and
wherein an object image obtained using the zoom lens is combined with the image obtained using the wide-angle lens, excluding an area corresponding to the object image.

8. The method of claim 7, wherein the excluding of an area corresponding to the object image obtained using the zoom lens from an image obtained using the wide-angle lens comprises:
setting a common reference point for photography to the specific object when images are taken using the zoom lens and the wide-angle lens;
determining image areas to be photographed with the zoom lens and wide-angle lens using a position measuring system of the mobile communication terminal; and
excluding the image area obtained with the zoom lens from the image area obtained with the wide-angle lens using the position measuring system.

9. The method of claim 6, wherein the position measuring system of the mobile communication terminal comprises at least one of a local area communication system, an ultrasonic position measuring system, and a Global Positioning System (GPS).

10. The method of claim 1, wherein the setting of an object occurs in an image-combining mode of operation for the plurality of camera lenses.

11. The method of claim 1, further comprising selecting one of an image-taking mode and an image-combining mode for operating the plurality of camera lenses, the setting an object for the plurality of camera lenses, taking images using the plurality of camera lenses, and combining together the images obtained using the plurality of camera lenses each occurring in the image-combining mode.

12. The method of claim 11, further comprising selecting at least one of the pluralities of camera lenses to take an image in the image-taking mode.

13. The method of claim 12, further comprising converting the mode of the mobile communication terminal from the image-taking mode to the image-combining mode if the mobile communication terminal is set to an image-taking mode.

14. An apparatus for taking images using a mobile communication terminal, comprising:
a photographing unit having a plurality of camera lenses comprising at least one zoom lens and at least one wide-angle lens;
an object setter for setting an object for the plurality of camera lenses; and
an image combiner for combining together images obtained using the plurality of lenses.

15. The apparatus of claim 14, wherein the image combiner combines images obtained using the zoom lens and the wide-angle lens.

16. The apparatus of claim 14, wherein the object setter is configured to set a reference position for photography for the plurality of camera lenses.

17. The apparatus of claim 16, wherein the object setter comprises a position measuring system for the mobile communication terminal to set the reference position.

18. The apparatus of claim 14, wherein the plurality of camera lenses comprises a zoom lens and a wide-angle lens, and the image combiner is configured to combine together an object image obtained using the zoom lens with an image obtained from the wide-angle lens excluding an area corresponding to the object image.

19. The apparatus of claim 14, further comprising a mode setter for setting of one of an image-taking mode in which an object is photographed and an image-combining mode, the image-combining mode comprising setting the object for the plurality of camera lenses, taking images using the plurality of camera lenses, and combining together the images obtained using the plurality of camera lenses.
